(19) United States
(12) Patent Application Publication
(10) Pub. No.: US 2026/0135626 A1
(43) Pub. Date: May 14, 2026

(54) RADIO FREQUENCY (RF) CALIBRATION USING MACHINE LEARNING-ENHANCED SIMULATION DATA

(71) Applicant: QUALCOMM Incorporated, San Diego, CA (US)

(72) Inventors: Sree Venkatesh Thatavarthy, Bangalore (IN); Mehran Bakhshiani, San Diego, CA (US); Swamy Mogilikolla, Bangalore (IN); Chanukya Sai Mendu, Bangalore (IN)

(21) Appl. No.: 18/943,661

(22) Filed: Nov. 11, 2024

(51) Int. Cl. H04B 17/11; H04B 1/04

(52) U.S. Cl. CPC H04B 17/11; H04B 1/04

(57) ABSTRACT

Techniques for optimizing radio frequency (RF) calibration involves using machine learning to enhance and expand simulation data. The techniques include receiving a first set of calibration data derived from device simulations for a subset of operating scenarios. A machine learning model generates a second, larger set of calibration data. Performance boundary contours are created based on the expanded data that represent a second-order intercept point metric across calibration parameter combinations. Multiple performance regions within these contours are identified and ranked. An optimized calibration parameter set is then generated based on the ranked performance regions. This approach allows for calibration using a reduced initial dataset and decreases simulation time and memory requirements for calibration data storage in RF devices.

### TECHNICAL FIELD

This disclosure relates generally to wireless communication, and more specifically, to techniques for optimizing radio frequency (RF) calibration using machine learning to expand simulation data where a set of calibration parameters are generated from a subset of simulated scenarios.

### BACKGROUND

Wireless communication networks are widely deployed to provide various communication services such as voice, video, packet data, messaging, broadcast, and the like. These wireless networks may be multiple-access networks capable of supporting multiple users by sharing the available network resources. A wireless communication network may include several components. These components may include Radio frequency integrated circuits (RFICs) that require calibration to ensure optimal performance across various operating conditions. One parameter for RFIC calibration is the second-order intercept point (IP2TX), which impacts receiver sensitivity and system performance.

RFIC calibration has relied on extensive simulation data to generate look-up tables (LUTs) for different operating scenarios including, e.g., various frequency bands, bandwidths, and receiver configurations. This approach has become increasingly challenging due to the growing complexity of wireless systems. For instance, modern RFICs must now support numerous downlink channels, frequency bands, carrier aggregation scenarios, and ports. This leads to a significant increase in the number of calibration scenarios that must be accounted for during calibration.

The expanding number of calibration scenarios results in at least two significant challenges: (1) increased simulation time, and (2) increased memory requirements. With regard to increased simulation time, generating meaningful calibration data for all possible scenarios has become prohibitively time-consuming, impacting design and production timelines. With regard to increased memory requirements, extensive calibration data necessitates larger memory allocations, typically in one-time programmable memories.

Compounding the problem, current electronic design automation (EDA) tools often lack the sophistication to efficiently generate the large calibration datasets. And the inability to accurately estimate calibration requirements during pre-fabrication further complicates the design process.

As wireless technologies continue to evolve, there is a need for efficient calibration techniques that maintain or improve RFIC performance while reducing simulation time and memory requirements. Accordingly, an approach that extrapolates from limited datasets and optimizes calibration parameter reuse across multiple scenarios would be beneficial in RFIC design and manufacturing, and wireless communications in general.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above. The systems, methods and devices of this disclosure each have several innovative aspects, no single one of which is solely responsible for the desirable attributes disclosed herein.

One innovative aspect of the subject matter described in this disclosure can be implemented in an apparatus for wireless communication. The apparatus includes one or more memories that store processor-executable code and one or more processors coupled with the one or more memories. The processors are configured to receive first calibration data associated with a plurality of operating scenarios for a Radio Frequency Integrated Circuit (RFIC), generate one or more performance boundary contours based on the first calibration data, identify a plurality of performance regions among the one or more performance boundary contours, rank the plurality of performance regions, and generate an optimized calibration parameter set for the plurality of operating scenarios based on the ranked performance regions.

In some examples, the apparatus includes a machine learning model to output second calibration data for scenarios not included in the first calibration data. The apparatus may determine minimum performance metric values across environmental conditions, calculate similarity metrics for performance regions, evaluate performance variations across process, voltage, or temperature conditions, and identify representative parameter sets for groups of operating scenarios meeting performance criteria across test conditions.

Another innovative aspect of the subject matter described in this disclosure can be implemented in a method for radio frequency (RF) calibration optimization. The method includes receiving first calibration data associated with a plurality of operating scenarios for an RFIC, generating one or more performance boundary contours based on the first calibration data, identifying a plurality of performance regions among the performance boundary contours, ranking the plurality of performance regions, and generating an optimized calibration parameter set for the plurality of operating scenarios based on the ranked performance regions.

In some examples, the method involves using a machine learning model to output second calibration data for scenarios not included in the first calibration data. The method may include determining minimum performance metric values across environmental conditions, calculating similarity metrics for performance regions, evaluating performance variations across various conditions, and identifying representative parameter sets for groups of operating scenarios.

A further innovative aspect of the subject matter described in this disclosure can be implemented in another method for RF calibration optimization. This method includes receiving a first set of calibration data for an RFIC derived from device simulations, generating a second set of calibration data using a machine learning model, and generating a set of optimized calibration parameters based on the second set of calibration data.

In some examples, this method involves generating performance boundary contours based on the second set of calibration data, identifying and ranking multiple performance regions among these contours. The first set of calibration data may comprise approximately 25% of total calibration data, while the second set comprises approximately 75%. The method may include storing the optimized calibration parameters in the RFIC's memory and evaluating performance variations across various conditions for multiple operating scenarios.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

In an additional aspect of the disclosure, an apparatus includes means for receiving first calibration data associated with a plurality of operating scenarios for a Radio Frequency Integrated Circuit (RFIC); means for generating one or more performance boundary contours based on the first calibration data, wherein the one or more performance boundary contours represent a second-order intercept point (IP2TX) metric across calibration parameter combinations; means for identifying a plurality of performance regions among the one or more performance boundary contours, wherein each of the plurality of performance regions corresponds to a subset of the plurality of operating scenarios; means for ranking the plurality of performance regions; and means for generating an optimized calibration parameter set for the plurality of operating scenarios based on the ranked performance regions, wherein the optimized calibration parameter set is applicable across the plurality of operating scenarios.

In an additional aspect of the disclosure, a non-transitory computer-readable medium stores instructions that, when executed by a processor, cause the processor to perform operations. The operations include receiving first calibration data associated with a plurality of operating scenarios for a Radio Frequency Integrated Circuit (RFIC); generating one or more performance boundary contours based on the first calibration data, wherein the one or more performance boundary contours represent a second-order intercept point (IP2TX) metric across calibration parameter combinations; identifying a plurality of performance regions among the one or more performance boundary contours, wherein each of the plurality of performance regions corresponds to a subset of the plurality of operating scenarios; ranking the plurality of performance regions; and generating an optimized calibration parameter set for the plurality of operating scenarios based on the ranked performance regions, wherein the optimized calibration parameter set is applicable across the plurality of operating scenarios.

An additional aspect of the disclosure, an apparatus includes means for performing the method of radio frequency (RF) calibration optimization, including means for receiving first calibration data associated with a plurality of operating scenarios for a Radio Frequency Integrated Circuit (RFIC); means for generating one or more performance boundary contours based on the first calibration data; means for identifying a plurality of performance regions among the one or more performance boundary contours; means for ranking the plurality of performance regions; and means for generating an optimized calibration parameter set for the plurality of operating scenarios based on the ranked performance regions.

In an additional aspect of the disclosure, a non-transitory computer-readable medium stores instructions that, when executed by a processor, cause the processor to perform operations for radio frequency (RF) calibration optimization. The operations include receiving a first set of calibration data for a Radio Frequency Integrated Circuit (RFIC), wherein the first set of calibration data is derived from one or more device simulations; generating, using a machine learning model, a second set of calibration data, wherein the second set of calibration data is larger than the first set of calibration data; and generating a set of optimized calibration parameters based on the second set of calibration data.

As used herein, a “radio frequency” signal is a signal having a frequency above baseband, which includes, in an example embodiment of a heterodyne receiver, intermediate frequency signals.

As used herein, an “intermediate frequency” signal is a RF signal that has been downconverted from another RF signal to a frequency that is above baseband, such as in an example embodiment of a heterodyne mmWave transceiver that receives a mmWave RF signal and downconverts the mmWave RF signal to a mmWave IF signal that is further processed, such as through further downconversion, to a lower frequency RF signal or a baseband signal.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station (BS) and a user equipment (UE) according to one or more aspects.

FIG. 3 is a block diagram illustrating a radio frequency (RF) transceiver according to one or more aspects.

FIG. 4 is a flowchart illustrating an example process for radio frequency (RF) calibration optimization performable by a wireless communication device according to one or more aspects of the disclosure.

FIG. 5 is a flowchart illustrating another example process for radio frequency (RF) calibration optimization performable by a wireless communication device according to one or more aspects of the disclosure.

FIG. 6 is a flowchart illustrating an advanced process for radio frequency (RF) calibration optimization performable by a wireless communication device according to one or more aspects of the disclosure.

FIG. 7 is a block diagram of an example UE that supports RF calibration optimization in a wireless radio according to one or more aspects of the disclosure.

FIG. 8 is a block diagram of an example base station that supports RF calibration optimization in a wireless radio according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure relates to techniques for optimizing radio frequency (RF) calibration in integrated circuits for wireless communications. By reducing calibration data storage requirements, the techniques maintain or improve performance across a wide range of operating scenarios. Machine learning is utilized for expanding a limited set of simulated calibration data into a comprehensive dataset. Initially, calibration data is obtained for a subset of operating scenarios, approximately 25% of the total in some implementations. A deep neural network or similar machine learning model then predicts calibration data for the remaining scenarios to complete the dataset.

Performance boundary contours are generated based on the expanded dataset. The contours encompass or represent parameters such as the second-order intercept point (IP2TX) across various calibration parameter combinations. Analysis of these contours leads to the identification of distinct performance regions that each correspond to a subset of operating scenarios. According to an aspect, the performance regions are ordered or ranked to inform the generation of an optimized set of calibration parameters. Configured for applicability across multiple operating scenarios, the optimized set reduces required storage for calibration data.

According to an aspect, similarity metrics are calculated for the performance regions. The similarity metrics can be based on, e.g., the commonality between calibration parameter combinations. Such calculations facilitate a grouping of similar operating scenarios, which further streamlines the calibration process. Some aspects also evaluate performance variations across process, voltage, and temperature conditions to ensure efficient operation across different environments. The foregoing approach allows for effective management of numerous downlink channels, frequency bands, and carrier aggregation scenarios.

Particular implementations of the subject matter described in this disclosure may be implemented to realize one or more of the following potential advantages or benefits. In some aspects, the present disclosure provides techniques for substantially reducing the memory footprint required for storing RF calibration data in integrated circuits. By using machine learning to expand a limited set of simulated data, implementations allow for a comprehensive calibration approach while only requiring a fraction of the simulation time and data storage typically needed. This yields significant cost savings in chip design and manufacturing as well as improved performance in devices with limited memory resources.

Generating and analyzing performance boundary contours enables a nuanced understanding of RF performance across different operating scenarios. Doing so also allows for efficient grouping of scenarios that can share calibration parameters to further reduce data storage requirements without compromising performance. Also, ordering or ranking performance regions provides a meaningful way to prioritize important calibration parameters.

By applying aspects of the calibration optimization techniques disclosed herein, RF integrated circuit designers can adapt to the increasing complexity of modern wireless systems. The ability to handle numerous downlink channels, frequency bands, and carrier aggregation scenarios with a reduced calibration dataset allows for more flexible and capable RF designs. This can be particularly beneficial in the development of multi-band, multi-mode wireless devices where efficient use of resources is paramount.

Machine learning aspects of this disclosure not only reduce the amount of simulation required but also improve the accuracy of calibration across a wider range of operating conditions. By learning from the relationships in the simulated data the model can interpolate and extrapolate to scenarios that might be difficult or time-consuming to simulate directly.

Finally, the automated nature of calibration optimization techniques disclosed herein streamline RF design by reducing manual effort required in generation and analysis of calibration data. This yields faster development cycles and rapid iteration in RF integrated circuit design.

Specific implementations are now discussed to further illustrate the foregoing. In certain implementations, the calibration optimization process is initiated with simulation data centered around a range of codes, e.g., spanning a Center Code±15 codes in steps of 2. The simulation data can undergo initial processing to account for Process, Voltage, and Temperature (PVT) variations to create a set of processed data. The system can also incorporate Operating Specification (OSPEC) data, which defines required performance parameters. Both the processed PVT data and the OSPEC data serve as inputs to a customized neural network that forms a basis of a deep learning process.

The neural network can be configured or configured to model each frequency band individually to learn the complex relationships between operating parameters and performance metrics. The output of the deep learning process is an expanded set of calibration data that effectively predicts performance across a much wider range of scenarios than initially simulated. The expanded dataset can be fed into a complex analysis phase where the system identifies overlapping performance regions across multiple frequency bands. This process can generate millions of potential overlap scenarios, where each scenario represents a possible shared calibration setting across different operating conditions.

The overlap scenarios then undergo an ordering or ranking process where they are prioritized based on, e.g., their potential for calibration data reuse. The ranking criteria may include factors such as the number of bands covered, the range of operating conditions encompassed, and the degree of performance maintained. A yield analysis can be performed on the ranked overlap data to evaluate how well each ranked overlap scenario performs across the full range of operating conditions. Doing so ensures that the prioritized calibration settings maintain required performance levels across relevant scenarios. Finally, the results of the yield analysis can be used to construct a reuse table that maps optimized calibration parameters to specific operating scenarios.

Calibration optimization results according to one implementation are represented in TABLE 1:

TABLE 1

| | | No. | | |
|---|---|---|---|---|
| Reuse | Reuse | of | | |
| Group | Scenario | Bands | Cal Band | BAND GROUP |
| 0 | ILNA_PMHB3JB | 5 | B7_DLP5_LGY_10M | (‘B1_DLP5_LGY_10M_Div4’, |
| | | | | ‘B2_DLP5_SCA1_10M_Div4’, |
| | | | | ‘B3_DLP5_SCA1_10M_Div4’, |
| | | | | [symbol] B66_DLP5_LGY_10M_Div4’, |
| | | | | [symbol] B7_DLP5_LGY_10M_Div4’) |
| 1 | ILNA_PMHB3JB | 5 | B7_DLP3_LGY_10M | (‘B1_DLP3_LGY_10M_Div4’, |
| | | | | ‘B2_DLP3_SCA1_10M_Div4’, |
| | | | | ‘B3_DLP3_SCA1_10M_Div4’, |
| | | | | [symbol] B66_DLP3_LGY_10M_DIV4’, |
| | | | | [symbol] B7_DLP3_LGY_10M_Div4’) |
| 2 | ILNA_PMHB3JB | 3 | B11_DLP5_LGY_10M | [symbol] ‘B11_DLP5_LGY_10M_Div6’, |
| | | | | [symbol] B2_DLP5_LGY_10M_Div4’, |
| | | | | [symbol] B3_DLP5_LGY_10M_Div4’) |
| 3 | ILNA_PMHB3JB | 2 | B2_DLP3_LGY_10M | (‘B2_DLP3_LGY_10M_Div4’ |
| | | | | [symbol] B3_DLP3_LGY_10M_Div4’,) |
| 4 | ILNA_PMHB3JB | 1 | B40_DLP5_LGY_80M | [symbol] ‘B40_DLP5_LGY_80M_Div4’,) |
| 5 | ILNA_PMHB3JB | 1 | B40_DLP3_LGY_80M | [symbol] ‘B40_DLP3_LGY_80M_Div4’,) |
| 6 | ILNA_PMHB3JB | 1 | B30_DLP5_LGY_10M | [symbol] ‘B30_DLP5_LGY_10M_Div4’,) |
| 7 | ILNA_PMHB3JB | 1 | B11_DLP3_LGY_10M | [symbol] ‘B11_DLP3_LGY_10M_Div4’,) |
| 8 | ILNA_PMHB3JB | 1 | B30_DLP3_LGY_10M | [symbol] ‘B30_DLP3_LGY_10M_Div4’,) |

| | YIELD | | | | | wC | | |
|---|---|---|---|---|---|---|---|---|
| | 48- | | Passing | wC | | IP2TX | | |
| Reuse | Devices | Passing | Code | Code | | Margin | | |
| Group | (%) | Codes | Criteria | Margin | wC_Device | (dB) | wC_SPEC | wC_lp2TX |
| 0 | 100 | 81 | 50 | 4 codes | SS3P0 | 9.3 | 73 | 82.3 |
| 1 | 100 | 71 | 50 | 3 codes | FF3P0 | 9.94 | 69.6 | 79.54 |
| 2 | 100 | 54 | 50 | 2 codes | SS3P0 | 6.32 | 73 | 79.32 |
| 3 | 100 | 90 | 50 | 3 codes | SS3P0 | 10.45 | 73 | 83.45 |
| 4 | 100 | 151 | 50 | 3 codes | SS3P0 | 6.29 | 73 | 79.29 |
| 5 | 100 | 139 | 50 | 3 codes | SS3P0 | 6.68 | 73 | 79.68 |
| 6 | 100 | 79 | 50 | 4 codes | SS1P5 | 9.54 | 69 | 78.54 |
| 7 | 100 | 68 | 50 | 3 codes | NN | 6.98 | 73 | 79.98 |
| 8 | 100 | 59 | 50 | 3 codes | FF3P0 | 8.39 | 69 | 77.39 |

[symbol]

indicates data missing or illegible when filed

TABLE 1 covers multiple band scenarios and includes parameters such as worst-case IP2TX performance achieved, worst-case specification requirement, the margin between achieved performance and specification, worst-case device condition, worst-case code margin, threshold for acceptable codes, number of codes meeting the criteria, percentage yield across test devices, groups of bands that can share calibration settings, the band used for calibration, number of bands in each group, and specific scenarios for calibration reuse.

TABLE 1 illustrates a successful grouping of multiple bands for calibration reuse while maintaining high yield across test devices and meeting or exceeding performance specifications. That is, referring to TABLE 1, the “YIELD 48-Devices (%)” column, which shows a 100% yield across all groups, indicates that the calibration settings work effectively for all 48 test devices. The “BAND GROUP” column demonstrates how multiple bands are successfully grouped together. For example, the first group combines five bands (B1, B2, B3, B66, and B7) with the same downlink pipe (DLP5). This illustrates an ability to identify common calibration settings across different frequency bands.

Comparing the “Passing Codes” column to the “PassingCode Criteria” column shows that in all cases, the number of passing codes exceeds the criteria. For instance, in the first group, 81 codes pass against a criteria of 50, indicating a robust calibration solution. The “No. of Bands” column, ranging from 1 to 5, demonstrates flexibility in creating groups of various sizes to optimize calibration reuse. By examining the “Cal Band” column in conjunction with the “BAND GROUP” column, it can be seen how a single calibration band (e.g., B7_DLP5_LGY_10M) is used to calibrate multiple bands—effectively reducing the required calibration data. This reduction is achieved while maintaining performance, as evidenced by the consistent 100% yield and positive IP2TX margins across all groups.

TABLE 2 further illustrates the efficiency of calibration optimization according to an implementation.

TABLE 2

| GROUP SIZE | COUNT |
|---|---|
| 8 Bands | 5 |
| 6 Bands | 3 |
| 5 Bands | 1 |
| 4 Bands | 5 |
| 3 Bands | 10 |
| 2 Bands | 37 |
| Single Band | 57 |
| Reduced Cal Cases | 119 |
| Total Input Contours | 244 |

Referring to TABLE 2, calibration settings are organized into groups ranging from single band to multiple bands sharing settings. For instance, in the illustrated implementation, the grouping strategy resulted in 5 groups of 8 bands, 3 groups of 6 bands, 1 group of 5 bands, 5 groups of 4 bands, 10 groups of 3 bands, 37 groups of 2 bands, and 57 single band groups. This grouping approach significantly reduced the number of unique calibration cases from 244 to 119, representing a 48% reduction in calibration data storage requirements. This substantial reduction was achieved while maintaining performance across all operating scenarios, which underscores the effectiveness of the machine learning-based optimization approach.

In various implementations, the techniques and apparatus disclosed herein may be used for wireless communication networks such as code division plurality of access (CDMA) networks, time division plurality of access (TDMA) networks, frequency division plurality of access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently plurality of x services and features with a dynamic, low-latency time division duplex (TDD) design or frequency division duplex (FDD) design; and advanced wireless technologies, such as massive plurality of input, plurality of output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient plurality of xing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

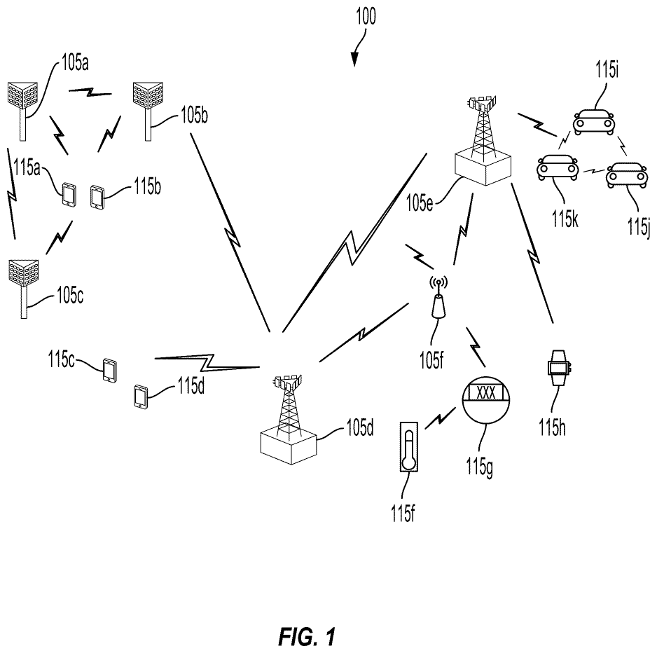

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or plurality of (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

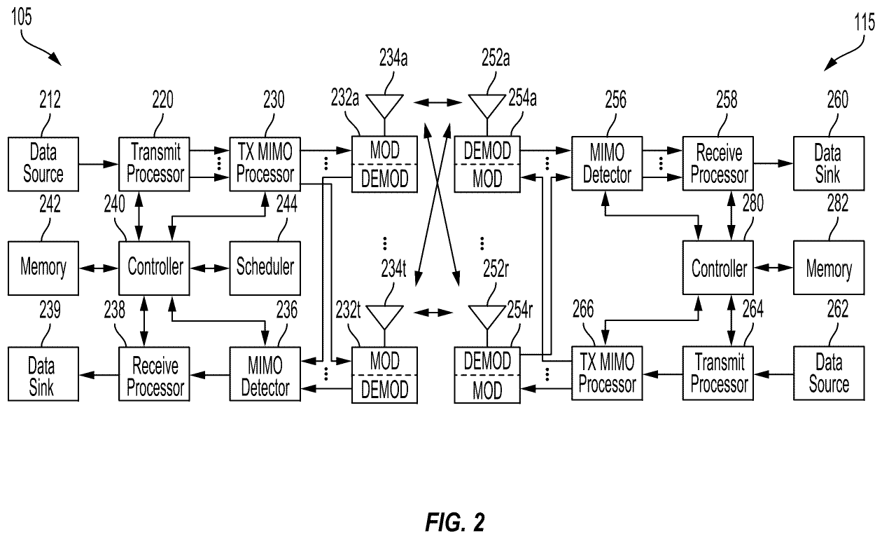

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

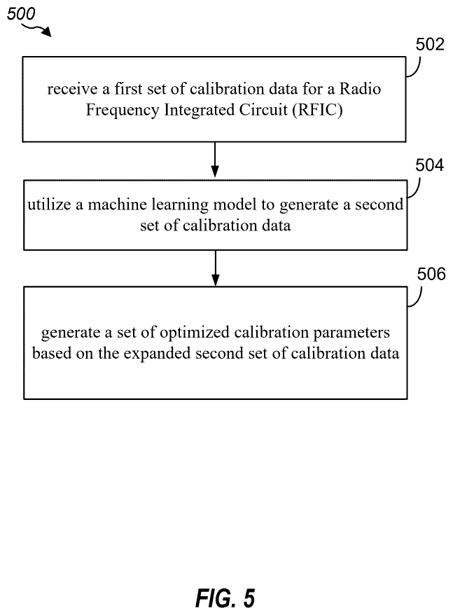

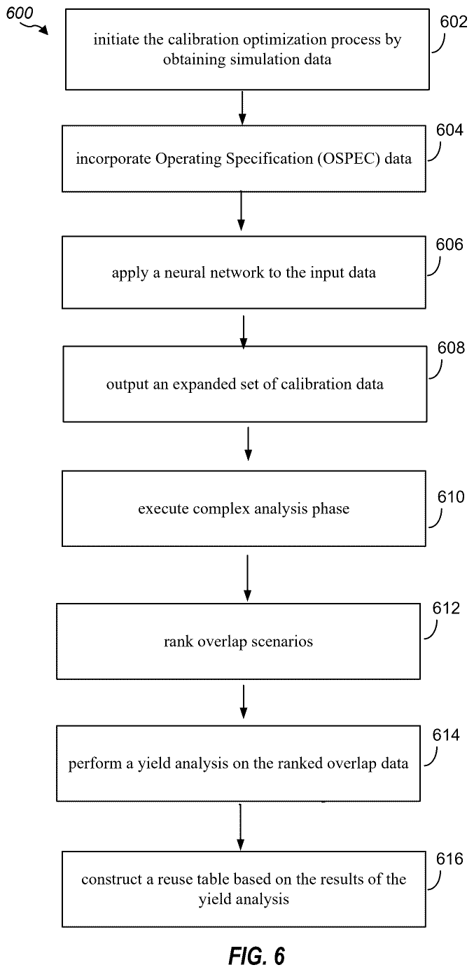

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5 or FIG. 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

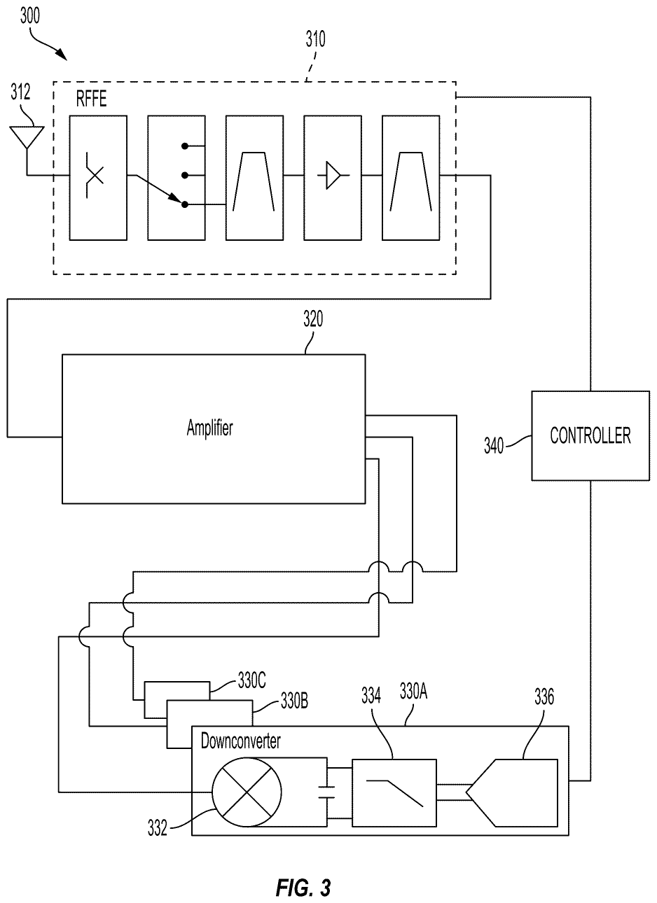

FIG. 3 is a block diagram illustrating a wireless receiver circuit 300 according to one or more aspects. In some embodiments, the receiver circuit 300 may be part of a converged sub-6 Ghz and mmWave radio frequency (RF) transceiver, a sub-6 GHz radio frequency (RF) transceiver, or a mmWave radio frequency (RF) transceiver. In some embodiments, portions or all of the RF transceiver of FIG. 3 may be located in a single integrated circuit (IC) sharing a common substrate. The receiver circuit 300 may include an antenna 312 to receive radio frequency (RF) signals, such as a phase antenna array. The antenna 312 is coupled to a RF front-end (RFFE) 310, which may include duplexers, SAW filters, switches, LNAs, and/or other transmit or receive circuits for conditioning signals received from the antenna 312. In some embodiments, the RFFE 310 may include separate circuits for conditioning or otherwise processing sub-6 GHz signals, mmWave signals, satellite signals, and/or other signals. For example, the RFFE 310 may include a first plurality of circuits for conditioning a sub-6 GHz signal for further processing by other circuitry and a second plurality of circuits for conditioning a mmWave RF signal for further processing by other circuitry. The output of the RFFE 310 in this example may be a input RF signal to other circuitry comprising the conditioned sub-6 GHz signal and a conditioned mmWave IF signal. The RFFE 310 is coupled to an amplifier 320, such as a low noise amplifier (LNA). The amplifier 320 is coupled to one or more downconverters 330A, 330B, and 330C. Each of the downconverters 330A, 330B, and 330C may include mixers 332, baseband filters (8Fs) 334, and/or analog-to-digital converters (ADCs) 336. The downconverters 330A, 330B, 330C may include one or more harmonic rejection mixers (HRMs). In some embodiments, the amplifier 320 is shared on an IC with one or more of the RFFE 310 and/or the downconverters 330A, 330B, and 330C.

Interference between wireless signals received at antenna 312 and processed through RFFE 310, amplifier 320, and downconverters 330A-C complicates operation of the receiver circuit 300, particularly when processing a large range of potential frequencies. For example, co-location of processing paths for sub-6 Ghz and mmWave signals in an integrated circuit can create interference between the sub-6 GHz signal harmonics and the mmWave signals. Interference between sub-6 GHz signals and mmWave signals may occur because mmWave IF signals corresponding to mmWave RF signals received at an antenna from over-the-air may be located near to sub-6 GHz signals in frequency (e.g., within 1-6 GHz) and/or located at harmonics of the sub-6 GHz (e.g., at integer plurality ofs of the sub-6 GHz signals).

Interference between wireless signals may be further complicated by carrier aggregation (CA) operation. Carrier aggregation (CA) involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change. As carriers are assigned and de-assigned from a mobile device, the interaction of wireless signals may change. For example, different carriers in CA may be in different bands, and certain bands may have harmonics that overlap and/or otherwise interfere with certain other bands.

A controller 340 may detect conditions in the RF signal received from the antenna 312 or receive information regarding the carrier configuration from higher levels, such as a MAC layer or network layer. The controller 340 may configure components of the receiver circuit 300 to activate, deactivate, or control portions of the receiver circuit 300 to process an input RF signal. In some embodiments, the controller 340 configures components to reduce interference between bands within the receiver circuit 300. In some embodiments, the controller 340 may configure components in one or more processing paths of mixers within the downconverters 330A, 330B, and 330C.

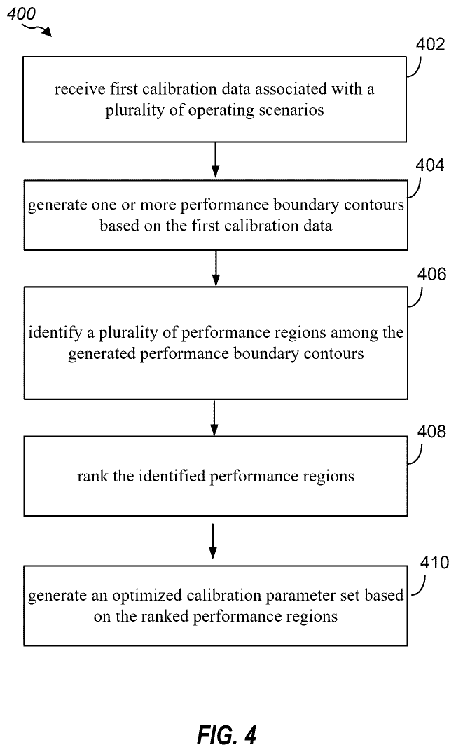

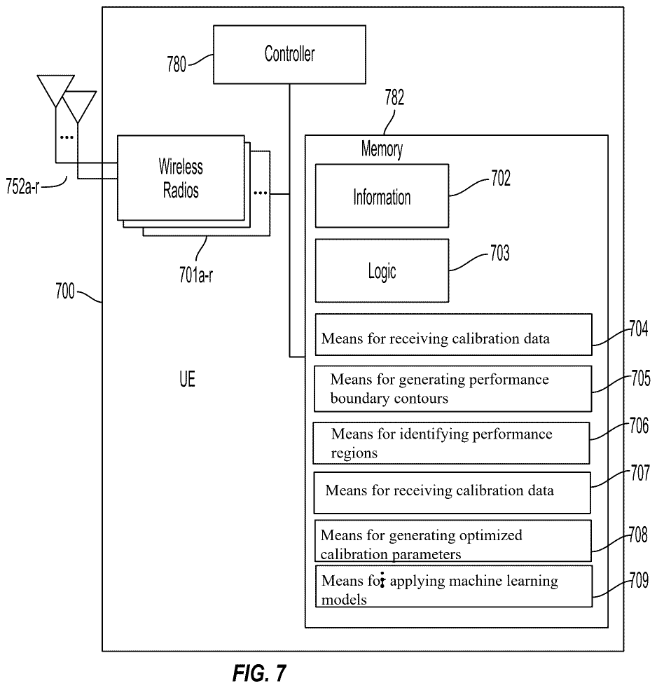

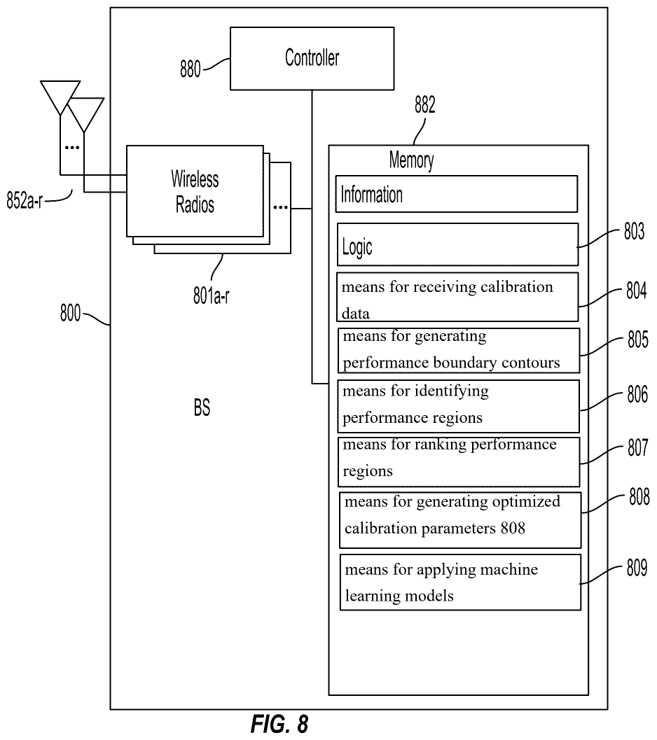

FIG. 4 shows a flowchart illustrating an example process 400 performable by or at a wireless communication device that supports radio frequency (RF) calibration optimization according to aspects described herein. The operations of the process 400 may be implemented by a wireless communication device or its components as described herein. For example, the process 400 may be performed by a wireless communication device, such as a UE 115 described with reference to FIG. 1 or UE 700 described with reference to FIG. 7, or a BS 105 described with reference to FIG. 1 or BS 800 described with reference to FIG. 8.

At step 402, the wireless communication device receives first calibration data associated with a plurality of operating scenarios. In some implementations, the operating scenarios are for a Radio Frequency Integrated Circuit (RFIC). The initial dataset provides a basis for the optimization process. In certain implementations, this first calibration data may be derived from, e.g., device simulations to provide a starting point for calibration process 400.

At step 404, the device generates one or more performance boundary contours based on the first calibration data. These contours can represent a second-order intercept point (IP2TX) metric across various calibration parameter combinations. According to one aspect, the IP2TX metric serves as a key indicator of RF performance, allowing a wireless communication device to map out acceptable operating regions across different scenarios.

At step 406, the wireless communication device identifies a plurality of performance regions among the generated performance boundary contours. Each of the regions corresponds to a subset of the plurality of operating scenarios, effectively grouping similar operating conditions. Step 406 enables efficient handling of diverse operating scenarios an RFIC operating at or within a wireless communication device may encounter.

At step 408, the wireless communication device ranks the identified performance regions. Here, ranking or ordering the identified performance region enables prioritization of important or frequently encountered scenarios to ensure that the subsequent optimization steps focus on the most impactful areas of operation.

At step 410, the wireless communication device generates an optimized calibration parameter set based on the ranked performance regions. The optimized parameter set is configured to be applicable across the plurality of operating scenarios to provide a calibration solution that balances performance across various conditions.

In some implementations, the wireless communication device may perform additional steps to refine and expand the calibration process. For instance, it may output second calibration data for operating scenarios not included in the first calibration data. In some implementations, a machine learning model is utilized to extrapolate beyond the initial dataset. Doing so allows for broader coverage of potential operating conditions without the need for exhaustive initial simulations or measurements.

The wireless communication device may also determine minimum performance metric values across various environmental conditions for the range of calibration parameter combinations. This ensures that the optimized calibration parameters meet performance requirements under varying or challenging conditions.

In certain aspects, the operating scenarios considered in process 400 may encompass a combination of factors such as downlink channels, frequency bands, signal bandwidths, number of receiver ports, and receiver input configurations. This approach allows for a calibration that accounts for the complex interplay of various RF parameters. To further refine the ranking process, the wireless communication device may calculate similarity metrics for performance regions. The metrics can be based on the degree of commonality between calibration parameter combinations within different regions.

The wireless communication device may also evaluate performance variations across process, voltage, or temperature conditions for the operating scenarios to ensure that optimized calibration parameters remain effective across a range of operating conditions. In some implementations, the device identifies a representative parameter set for groups of operating scenarios. This set is associated with configurations that meet performance criteria across a range of test conditions, providing a calibration solution that can be applied more broadly.

FIG. 5 illustrates an example process 500 for radio frequency (RF) calibration optimization according to aspects described herein performable by a wireless communication device. The operations of process 500 may be implemented by various wireless communication devices or their components as described herein, such as a UE 115 described with reference to FIG. 1 or UE 700 described with reference to FIG. 7, or a BS 105 described with reference to FIG. 1 or BS 800 described with reference to FIG. 8.

At step 502, the wireless communication device receives a first set of calibration data for a Radio Frequency Integrated Circuit (RFIC). This initial dataset is derived from one or more device simulations, providing a starting point for the calibration optimization process. Here, device simulations are a computationally efficient way to generate initial calibration data without extensive physical testing.

At step 504, the wireless communication device utilizes a machine learning model to generate a second set of calibration data. The second set is larger than the first set and represents and expanded range of calibration scenarios. Machine learning enables the device to extrapolate from the limited initial dataset and cover a wider range of operating conditions without the need for additional simulations or measurements.

At step 506, the wireless communication device generates a set of optimized calibration parameters based on the expanded second set of calibration data. By leveraging the broader dataset produced by the machine learning model, the wireless communication device can create a more comprehensive set of calibration parameters.

In some implementations, process 500 may include additional steps to refine the calibration further. For instance, the wireless communication device can generate one or more performance boundary contours based on the second set of calibration data. These contours can represent a second-order intercept point (IP2TX) metric across various calibration parameter combinations and provide a visual or mathematical representation of acceptable operating regions.

The wireless communication device may also identify multiple performance regions among the contours. Each region corresponds to a subset of operating scenarios for the RFIC. Subsequently, the wireless communication device may rank the performance regions based on one or more criteria. This allows for prioritization of the most important or frequently encountered scenarios.

According to one aspect, the first set of calibration data comprises approximately 25% of the total calibration data for the RFIC, while the machine learning-generated second set comprises the remaining 75%. This balance significantly reduces the need for extensive initial simulations while still providing comprehensive coverage of potential operating conditions.

Once the optimized calibration parameters are generated, the wireless communication device may store them in memory (e.g., an RFIC's memory). Storing the parameters on-chip allows for efficient access during operation. The process of generating optimized calibration parameters may involve evaluating performance variations across different conditions. For example, the wireless communication device can assess how the RFIC (or other component) performs under varying process, voltage, or temperature conditions for a range of operating scenarios. This evaluation ensures that the optimized parameters remain effective across diverse range of operating conditions.

FIG. 6 illustrates an example process 600 for advanced RF calibration optimization performable by a wireless communication device. The operations of process 600 may be implemented by various wireless communication devices or their components as described herein, such as a UE 115 described with reference to FIG. 1 or UE 700 described with reference to FIG. 7, or a BS 105 described with reference to FIG. 1 or BS 800 described with reference to FIG. 8.

At step 602, the wireless communication device initiates the calibration optimization process by obtaining simulation data. The obtained data can center around a range of codes, e.g., spanning a Center Code±15 codes in steps of 2. Subsequently, the wireless communication device processes this simulation data to account for Process, Voltage, and Temperature (PVT) variations, creating a comprehensive set of processed data.

At step 604, the wireless communication device incorporates Operating Specification (OSPEC) data, which defines the required performance parameters. Both the processed PVT data and the OSPEC data serve as inputs for subsequent steps.

At step 606, the wireless communication device applies a neural network to the input data. A deep learning module, centered around the neural network, is configured to model each frequency band individually. Through this modeling, the neural network learns the complex relationships between various operating parameters and performance metrics.

At step 608, the deep learning process outputs an expanded set of calibration data. The expanded dataset effectively predicts performance across a much wider range of scenarios than those initially simulated and provides a more comprehensive basis for optimization.

At step 610, a complex analysis phase is executed. Here, overlapping performance regions are identified across multiple frequency bands. Often, millions of potential overlap scenarios can be generated, each representing a possible shared calibration setting across different operating conditions.

At 612, the wireless communication device ranks or orders these overlap scenarios. Prioritization is based on their potential for calibration data reuse, considering factors such as the number of bands covered, the range of operating conditions encompassed, and the degree of performance maintained.

At step 614, the wireless communication device performs a yield analysis on the ranked overlap data. An evaluation of how well each ranked overlap scenario performs across the full range of operating conditions ensures that the prioritized calibration settings maintain required performance levels across all relevant scenarios.

At step 616, the wireless communication device constructs a reuse table based on the results of the yield analysis. A reuse table efficiently maps optimized calibration parameters to specific operating scenarios and reduces the amount of calibration data that needs to be stored while maintaining coverage of all required operating conditions. As seen, process 600 enables the wireless communication device to achieve significant optimization in RF calibration, balancing performance requirements with efficient use of resources and storage.

Operations of methods 400, 500, and 600 may be performed by a UE, such as UE 115 described above with reference to FIG. 1 or FIG. 2, or a UE described with reference to FIG. 7. For example, operations of methods 400, 500, and 600 may enable UE 115 to support radio frequency (RF) calibration optimization for a Radio Frequency Integrated Circuit (RFIC).

FIG. 7 is a block diagram of an example UE 700 that supports RF calibration optimization according to one or more aspects of the disclosure. UE 700 may be configured to perform operations, including the blocks of processes described with reference to methods 400, 500, and 600. In some implementations, UE 700 includes the structure, hardware, and components shown and described with reference to UE 115 of FIG. 1 or FIG. 2. For example, UE 700 includes controller 780, which operates to execute logic or computer instructions stored in memory 782, as well as controlling the components of UE 700 that provide the features and functionality of UE 700. UE 700, under control of controller 780, transmits and receives signals via wireless radios 701a-r and antennas 752a-r. Wireless radios 701a-r include various components and hardware, as illustrated in FIG. 2 for UE 115, including modulator and demodulators 254a-r, MIMO detector 256, receive processor 258, transmit processor 264, and TX MIMO processor 266. Wireless radios 701a-r may also include one or more receiver circuits with RFICs configured for optimized calibration.

As shown, memory 782 may include information 702, logic 703, means for receiving calibration data 704, means for generating performance boundary contours 705, means for identifying performance regions 706, means for ranking performance regions 707, means for generating optimized calibration parameters 708, and means for applying machine learning models 709. Information 702 may be configured to include, for example, calibration data, performance metrics, and operating scenarios for the RFIC. Logic 703 may be configured to process the information 702, update the information 702, generate new calibration data, and/or store information regarding the current operating mode of the RFIC.

Means for receiving calibration data 704 may be configured to receive first calibration data associated with a plurality of operating scenarios for the RFIC, as described in methods 400 and 500. Means for generating performance boundary contours 705 may be configured to generate one or more performance boundary contours based on the calibration data, representing IP2TX metrics across calibration parameter combinations. Means for identifying performance regions 706 may be configured to identify multiple performance regions among the performance boundary contours, each corresponding to a subset of operating scenarios.

Means for ranking performance regions 707 may be configured to rank the identified performance regions based on predefined criteria. Means for generating optimized calibration parameters 708 may use the ranked performance regions to generate an optimized calibration parameter set applicable across multiple operating scenarios. Means for applying machine learning models 709 may be configured to generate additional calibration data using machine learning techniques, as described in method 500.

UE 700 may receive signals from or transmit signals to one or more network entities, such as base station 105 of FIG. 1 or FIG. 2 or a base station as illustrated in FIG. 8. Through the described components and processes, UE 700 can efficiently optimize RF calibration for its RFIC, reducing calibration data storage requirements while maintaining performance across diverse operating conditions.

FIG. 8 is a block diagram of an example base station 800 that supports RF calibration optimization according to one or more aspects of the disclosure. Base station 800 may be configured to perform operations, including the blocks of methods 400, 500, and 600 described with reference to FIGS. 4, 5, and 6. In some implementations, base station 800 includes the structure, hardware, and components shown and described with reference to base station 105 of FIG. 1 or FIG. 2. For example, base station 800 may include controller 240, which operates to execute logic or computer instructions stored in memory 242, as well as controlling the components of base station 800 that provide the features and functionality of base station 800. Base station 800, under control of controller 240, transmits and receives signals via wireless radios 801a-t and antennas 834a-t. Wireless radios 801a-t include various components and hardware, as illustrated in FIG. 2 for base station 105, including modulator and demodulators 232a-t, transmit processor 220, TX MIMO processor 230, MIMO detector 236, and receive processor 238. Wireless radios 801a-t may also include one or more RFICs configured for optimized calibration.

As shown, memory 882 may include information 802, logic 803, means for receiving calibration data 804, means for generating performance boundary contours 805, means for identifying performance regions 806, means for ranking performance regions 807, means for generating optimized calibration parameters 808, and means for applying machine learning models 809. Information 802 may be configured to include, for example, calibration data, performance metrics, operating scenarios for the RFIC, and simulation data. Logic 803 may be configured to process the information 802, update the information 802, generate new calibration data, and/or store information regarding the current operating mode of the RFIC.

Means for receiving calibration data 804 may be configured to receive first calibration data associated with a plurality of operating scenarios for the RFIC, as described in methods 400 and 500. This may include obtaining simulation data centered around a range of codes, e.g., spanning a Center Code±15 codes in steps of 2. Means for generating performance boundary contours 805 may be configured to generate one or more performance boundary contours based on the calibration data, representing IP2TX metrics across calibration parameter combinations. It may also process the simulation data to account for Process, Voltage, and Temperature (PVT) variations.

Means for identifying performance regions 806 may be configured to identify multiple performance regions among the performance boundary contours, each corresponding to a subset of operating scenarios. This component may also incorporate Operating Specification (OSPEC) data, which defines required performance parameters. Means for ranking performance regions 807 may be configured to rank the identified performance regions based on predefined criteria, such as the number of bands covered, the range of operating conditions encompassed, and the degree of performance maintained.

Means for generating optimized calibration parameters 808 may use the ranked performance regions to generate an optimized calibration parameter set applicable across multiple operating scenarios. This may involve performing a yield analysis on the ranked overlap data to evaluate how well each ranked overlap scenario performs across the full range of operating conditions. Means for applying machine learning models 809 may be configured to generate additional calibration data using machine learning techniques, as described in method 500. This component may employ a customized neural network configured to model each frequency band individually to learn the complex relationships between operating parameters and performance metrics.

In some embodiments, some of the wireless radios 801a-t may be configured for mmWave operation and others for sub-6 GHz operation. The base station 800 may use information regarding the physical location of certain wireless radios 801a-t relative to others to optimize calibration, particularly in scenarios involving potential interference between frequency bands.

Base station 800 may receive signals from or transmit signals to one or more UEs, such as UE 115 of FIG. 1 or FIG. 2 or UE 700 of FIG. 7. Through the described components and processes, base station 800 can efficiently optimize RF calibration for its RFICs, reducing calibration data storage requirements while maintaining performance across diverse operating conditions. The optimization process can generate millions of potential overlap scenarios, each representing a possible shared calibration setting across different operating conditions, and construct a reuse table that maps optimized calibration parameters to specific operating scenarios.

In one or more aspects, techniques for supporting wireless communications, such as on plurality of frequency bands, may include additional aspects, such as any single aspect or any combination of aspects described below or in connection with one or more other processes or devices described elsewhere herein. Supporting wireless communication may include an apparatus that performs or operates according to one or more aspects as described below. In some implementations, the apparatus includes a wireless device, such as a UE or a base station (BS). In some implementations, the apparatus may include at least one processor, and a memory coupled to the processor. The processor may be configured to perform operations described herein with respect to the apparatus, including operations described herein with respect to methods of operating a wireless device. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

Clause 1: A method for wireless communication, comprising: one or more memories that store processor-executable code; and one or more processors coupled with the one or more memories and individually or collectively configured to, in association with executing the code, cause the apparatus to: receive first calibration data associated with a plurality of operating scenarios for a Radio Frequency Integrated Circuit (RFIC); generate one or more performance boundary contours based on the first calibration data, wherein the one or more performance boundary contours represent a second-order intercept point (IP2TX) metric across calibration parameter combinations; identify a plurality of performance regions among the one or more performance boundary contours, wherein each of the plurality of performance regions corresponds to a subset of the plurality of operating scenarios; rank the plurality of performance regions; and generate an optimized calibration parameter set for the plurality of operating scenarios based on the ranked performance regions, wherein the optimized calibration parameter set is applicable across the plurality of operating scenarios.

Clause 2: The a method of Clause 1, wherein the one or more processors are further configured to cause the apparatus to: output second calibration data for at least one operating scenario not included in the first calibration data using a machine learning model.

Clause 3: The method of Clause 1, wherein the one or more processors are further configured to cause the apparatus to: determine a minimum performance metric value across at least one environmental condition for the range of calibration parameter combinations.

Clause 4: The method of Clause 1, wherein each of the plurality of operating scenarios comprises a combination of at least two of: a downlink channel, a frequency band, a signal bandwidth, a number of receiver ports, and a receiver input configuration.

Clause 5: The method of Clause 1, wherein the one or more processors are further configured to cause the apparatus to: calculate a similarity metric for two or more performance regions, wherein the similarity metric is based on a degree of commonality between the range of calibration parameter combinations within the two or more performance regions.

Clause 6: The method of Clause 1, wherein the one or more processors are further configured to cause the apparatus to: evaluate a performance variation across at least one of: a process condition, a voltage condition, or a temperature condition for the plurality of operating scenarios.

Clause 7: The method of Clause 1, wherein the one or more processors are further configured to cause the apparatus to: identify a representative parameter set for a group of operating scenarios associated with a maximum number of configurations meeting a performance criteria across a set of test conditions.

Clause 8: A method for radio frequency (RF) calibration optimization, comprising: receiving first calibration data associated with plurality of operating scenarios for a Radio Frequency Integrated Circuit (RFIC); generating one or more performance boundary contours based on the first calibration data, wherein the performance boundary contour represents a second-order intercept point (IP2TX) metric across a range of calibration parameter combinations; identifying plurality of performance regions among the one or more performance boundary contours, wherein each performance region corresponds to a subset of the plurality of operating scenarios; ranking the plurality of performance regions; and generating an optimized calibration parameter set for the plurality of operating scenarios based on the ranked performance regions, wherein the optimized calibration parameter set is applicable across the plurality of operating scenarios.

Clause 9: The method of Clause 8, further comprising: outputting, using a machine learning model, second calibration data for at least one operating scenario not included in the first calibration data.

Clause 10: The method of Clause 8, wherein generating the performance boundary contour comprises: determining a minimum performance metric value across at least one environmental condition for the range of calibration parameter combinations.

Clause 11: The method of Clause 8, wherein each of the plurality of operating scenarios comprises a combination of at least two of: a downlink channel, a frequency band, a signal bandwidth, a number of receiver ports, and a receiver input configuration.

Clause 12: The method of Clause 8, wherein ranking the plurality of performance regions comprises: calculating a similarity metric for two or more performance regions, wherein the similarity metric is based on a degree of commonality between calibration parameter combinations within the two or more performance regions.

Clause 13: The method of Clause 8, wherein generating the optimized calibration parameter set comprises: evaluating a performance variation across at least one of: a process condition, a voltage condition, or a temperature condition for the plurality of operating scenarios.

Clause 14: The method of Clause 8, wherein generating the optimized calibration parameter set comprises: identifying a representative parameter set for a group of operating scenarios associated with a maximum number of configurations meeting a performance criteria across a set of test conditions.

Clause 15: A method for radio frequency (RF) calibration optimization, comprising: receiving a first set of calibration data for a Radio Frequency Integrated Circuit (RFIC), wherein the first set of calibration data is derived from one or more device simulations; generating, using a machine learning model, a second set of calibration data, wherein the second set of calibration data is larger than the first set of calibration data; and generating a set of optimized calibration parameters based on the second set of calibration data.

Clause 16: The method of Clause 15, further comprising: generating one or more performance boundary contours based on the second set of calibration data, wherein the one or more performance boundary contours represent a second-order intercept point (IP2TX) metric across a range of calibration parameter combinations.

Clause 17: The method of Clause 16, further comprising: identifying plurality of performance regions among the one or more performance boundary contours, wherein each performance region corresponds to a subset of plurality of operating scenarios for the RFIC; and ranking the plurality of performance regions based on predefined criteria.

Clause 18: The method of Clause 15, wherein the first set of calibration data comprises approximately 25% of total calibration data for the RFIC, and the second set of calibration data comprises approximately 75% of the total calibration data.

Clause 19: The method of Clause 15, further comprising: storing the set of optimized calibration parameters in a memory of the RFIC.

Clause 20: The method of Clause 15, wherein generating the set of optimized calibration parameters comprises: evaluating performance variations across at least one of: a process condition, a voltage condition, or a temperature condition for plurality of operating scenarios of the RFIC.

Clause 21: An apparatus, including: at least one memory including executable instructions; and at least one processor configured to execute the executable instructions and cause the apparatus to perform a method in accordance with any combination of Clauses 1-20.

Clause 22: An apparatus, including means for performing a method in accordance with any combination of Clauses 1-20.

Clause 23: A non-transitory computer-readable medium including executable instructions that, when executed by at least one processor of an apparatus, cause the apparatus to perform a method in accordance with any combination of Clauses 1-20.

Clause 24: A computer program product embodied on a computer-readable storage medium including code for performing a method in accordance with any combination of Clauses 1-20.

Clause 25: A wireless node for wireless communication, comprising: one or more transceivers; one or more processors; and one or more memories comprising instructions executable by the one or more processors to cause the wireless node to perform a method in accordance with any combination of Clauses 1-20.

Clause 26: A wireless node for wireless communication, comprising: at least one transceiver; at least one memory including instructions; and one or more processors, individually or collectively, configured to perform a method in accordance with any combination of Clauses 1-20.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 1. As another example, one or more blocks associated with FIG. 4 may be combined with one or more blocks (or operations) associated with FIG. 1. Additionally, or alternatively, one or more operations described above with reference to FIGS. 1-4 may be combined with one or more operations described with reference to FIGS. 5-8.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof configured to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in plurality of implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into plurality of software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for wireless communication, comprising:
one or more memories that store processor-executable code; and
one or more processors coupled with the one or more memories and individually or collectively configured to, in association with executing the code, cause the apparatus to:
receive first calibration data associated with a plurality of operating scenarios for a Radio Frequency Integrated Circuit (RFIC);
generate one or more performance boundary contours based on the first calibration data, wherein the one or more performance boundary contours represent a second-order intercept point (IP2TX) metric across calibration parameter combinations;
identify a plurality of performance regions among the one or more performance boundary contours, wherein each of the plurality of performance regions corresponds to a subset of the plurality of operating scenarios;
rank the plurality of performance regions; and
generate an optimized calibration parameter set for the plurality of operating scenarios based on the ranked performance regions, wherein the optimized calibration parameter set is applicable across the plurality of operating scenarios.

2. The apparatus of claim 1, wherein the one or more processors are further configured to cause the apparatus to:
output second calibration data for at least one operating scenario not included in the first calibration data using a machine learning model.

3. The apparatus of claim 1, wherein the one or more processors are further configured to cause the apparatus to:
determine a minimum performance metric value across at least one environmental condition for the range of calibration parameter combinations.

4. The apparatus of claim 1, wherein each of the plurality of operating scenarios comprises a combination of at least two of: a downlink channel, a frequency band, a signal bandwidth, a number of receiver ports, and a receiver input configuration.

5. The apparatus of claim 1, wherein the one or more processors are further configured to cause the apparatus to:
calculate a similarity metric for two or more performance regions, wherein the similarity metric is based on a degree of commonality between the range of calibration parameter combinations within the two or more performance regions.

6. The apparatus of claim 1, wherein the one or more processors are further configured to cause the apparatus to:
evaluate a performance variation across at least one of: a process condition, a voltage condition, or a temperature condition for the plurality of operating scenarios.

7. The apparatus of claim 1, wherein the one or more processors are further configured to cause the apparatus to:
identify a representative parameter set for a group of operating scenarios associated with a maximum number of configurations meeting a performance criteria across a set of test conditions.

8. A method for radio frequency (RF) calibration optimization, comprising:
receiving first calibration data associated with plurality of operating scenarios for a Radio Frequency Integrated Circuit (RFIC);
generating one or more performance boundary contours based on the first calibration data, wherein the performance boundary contour represents a second-order intercept point (IP2TX) metric across a range of calibration parameter combinations;
identifying plurality of performance regions among the one or more performance boundary contours, wherein each performance region corresponds to a subset of the plurality of operating scenarios;
ranking the plurality of performance regions; and
generating an optimized calibration parameter set for the plurality of operating scenarios based on the ranked performance regions, wherein the optimized calibration parameter set is applicable across the plurality of operating scenarios.

9. The method of claim 8, further comprising:
outputting, using a machine learning model, second calibration data for at least one operating scenario not included in the first calibration data.

10. The method of claim 8, wherein generating the performance boundary contour comprises:
determining a minimum performance metric value across at least one environmental condition for the range of calibration parameter combinations.

11. The method of claim 8, wherein each of the plurality of operating scenarios comprises a combination of at least two of: a downlink channel, a frequency band, a signal bandwidth, a number of receiver ports, and a receiver input configuration.

12. The method of claim 8, wherein ranking the plurality of performance regions comprises:
calculating a similarity metric for two or more performance regions, wherein the similarity metric is based on a degree of commonality between calibration parameter combinations within the two or more performance regions.

13. The method of claim 8, wherein generating the optimized calibration parameter set comprises:
evaluating a performance variation across at least one of: a process condition, a voltage condition, or a temperature condition for the plurality of operating scenarios.

14. The method of claim 8, wherein generating the optimized calibration parameter set comprises:
identifying a representative parameter set for a group of operating scenarios associated with a maximum number of configurations meeting a performance criteria across a set of test conditions.

15. A method for radio frequency (RF) calibration optimization, comprising:
receiving a first set of calibration data for a Radio Frequency Integrated Circuit (RFIC), wherein the first set of calibration data is derived from one or more device simulations;
generating, using a machine learning model, a second set of calibration data, wherein the second set of calibration data is larger than the first set of calibration data; and
generating a set of optimized calibration parameters based on the second set of calibration data.

16. The method of claim 15, further comprising:
generating one or more performance boundary contours based on the second set of calibration data, wherein the one or more performance boundary contours represent a second-order intercept point (IP2TX) metric across a range of calibration parameter combinations.

17. The method of claim 16, further comprising:
identifying plurality of performance regions among the one or more performance boundary contours, wherein each performance region corresponds to a subset of plurality of operating scenarios for the RFIC; and
ranking the plurality of performance regions based on predefined criteria.

18. The method of claim 15, wherein the first set of calibration data comprises approximately 25% of total calibration data for the RFIC, and the second set of calibration data comprises approximately 75% of the total calibration data.

19. The method of claim 15, further comprising:
storing the set of optimized calibration parameters in a memory of the RFIC.

20. The method of claim 15, wherein generating the set of optimized calibration parameters comprises:
evaluating performance variations across at least one of: a process condition, a voltage condition, or a temperature condition for plurality of operating scenarios of the RFIC.
